(19) United States
(12) Patent Application Publication
(10) Pub. No.: US 2025/0123509 A1
(43) Pub. Date: Apr. 17, 2025

(54) LIQUID CRYSTAL BASED MODE FIELD DIAMETER OPTIMIZATION

(71) Applicant: META PLATFORMS, INC., Menlo Park, CA (US)

(72) Inventor: Pradip Sairam Pichumani, Fremont, CA (US)

(21) Appl. No.: 18/900,209

(22) Filed: Sep. 27, 2024

Related U.S. Application Data
(60) Provisional application No. 63/589,513, filed on Oct. 11, 2023.

(51) Int. Cl. G02F 1/13

(52) U.S. Cl. CPC G02F 1/1326

(57) ABSTRACT

Methods and systems for a fiber optic assembly to propagate light into a waveguide associated with a photonic integrated circuit are provided. The system may include a fiber optic, and a fiber optic core for directing light into the fiber optic assembly. The fiber optic assembly may include at least one transparent layer, metal layer, electrode layer, or a liquid crystal layer. The fiber optic may be aligned in a photonic integrated circuit, where an active feedback loop may be configured to control regions of the fiber optic assembly individually based on the potential difference at both sides of the liquid crystal layer, via electrode layers. The molecules of the liquid crystal layer may be configured to move, change, or be reoriented to direct light into the waveguide based on the potential difference.

### CROSS-REFERENCE TO RELATED APPLICATIONS

This application claims the benefit of U.S. Provisional Patent Application No. 63/589,513, filed Oct. 11, 2023, entitled “Liquid Crystal Based Mode Field Diameter Optimization,” the entire content of which is incorporated herein by reference.

### TECHNOLOGICAL FIELD

Examples of the present disclosure relate generally to methods and apparatuses for a fiber optic core.

### BACKGROUND

Modern data centers require high-speed data transmission and efficient network infrastructure. Fiber optics, made of glass or plastic, may transmit data as light signals, offering higher bandwidth and longer transmission distances without the need for signal boosters. Managing light loss is an aspect of fiber optic technology.

### BRIEF SUMMARY

Methods and systems are described for a fiber optic assembly which may be associated with the transmission of data. The fiber optic assembly may include a transparent layer, a metal layer, a conductive electrode layer, or a liquid crystal layer.

In an example, a system may include a fiber optic core of a fiber optic having a front and rear surface. The fiber optic may be associated with a waveguide, where the fiber optic may be arranged to guide light through the waveguide to a device to provide information to a user, such as visuals of an artificial reality display. The light may be guided through at least one fiber optic assembly and may be propagated through a waveguide to provide information for viewing by the user.

In an example, an apparatus may include one or more transparent layers and one or more etchings associated with the one or more transparent layers. One or more electrically conductive material layers may be associated with the one or more etchings. One or more conductive electrode layers may be associated with the one or more etchings. One or more liquid crystal layers may be associated with the one or more conductive electrode layers. The one or more liquid crystal layers may be positioned between one or more conductive electrode layers.

In an example, a method may include obtaining one or more transparent layers associated with a wire assembly. One or more etchings may be attached to the one or more transparent layers of the wire assembly. One or more electrically conductive material layers may be attached to the one or more etchings of the wire assembly. One or more conductive electrode layers may be attached to the one or more etchings of the wire assembly. One or more liquid crystal layers may be attached to the one or more conductive electrode layers. The one or more liquid crystal layers may be positioned between one or more conductive electrode layers.

In an example, a method may include attaching a first transparent layer to a planarized temporary substrate. The method may further include etching a first layer to the transparent layer and attaching a first metal layer to the first layer. The method may further include attaching a second transparent layer on top of the first transparent layer and the first metal layer and etching a second layer to the second transparent layer. The method may further include attaching a second metal layer to the second layer and attaching a third transparent layer on top of the second transparent layer and the second metal layer. The method may further include etching a third layer to the third transparent layer and attaching a conductive electrode layer to the third layer. The method may further include attaching a liquid crystal layer and creating a portion of a wire assembly. The liquid crystal layer may be positioned between conductive electrode layers. The method may further include replacing a top temporary planar substrate with a fourth transparent layer and performing a dual damascene etch. The method may further include attaching a third metal layer to the dual damascene etch.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1A, FIG. 1B and FIG. 1C is an example method of adding layers of a fiber optic assembly in accordance with an example of the present disclosure.

FIGS. 2A, 2B, 2C, 2D, 2E, 2F, 2G, 2H, 2I, 2J, 2K, 2L, 2M, 2N, 2O, and 2P are an illustrative cross-sectional side view of the layers of a fiber optic assembly in accordance with an example of the present disclosure.

FIG. 3 is an illustrative cross-sectional side view of a fiber optic assembly in accordance with an example of the present disclosure.

FIG. 4 is an illustrative cross-sectional view of a fiber optic and waveguide couple in accordance with an example of the present disclosure.

FIG. 5A and FIG. 5B is an illustration of a fiber optic in accordance with an example of the present disclosure.

FIG. 6A and FIG. 6B is an illustrative view of the fiber optic assembly associated with a fiber optic in accordance with an example of the present disclosure.

FIG. 7 is a side view of the terminal end of a fiber optic in accordance with an example of the present disclosure.

FIG. 8 illustrates an exemplary flowchart of directing light to a waveguide via fiber optic in accordance with an example of the present disclosure.

FIG. 9 illustrates an exemplary system in accordance with an example of the present disclosure.

FIG. 10 illustrates an exemplary head-mounted display (HMD) associated with artificial reality content in accordance with an example of the present disclosure.

FIG. 11 illustrates an example artificial reality system in accordance with an example of the present disclosure.

FIG. 12 illustrates an example computing device in accordance with an example of the present disclosure.

FIG. 13 illustrates an example computing system in accordance with an example of the present disclosure.

FIG. 14 illustrates an example flowchart illustrating operations associated with a wire assembly according to an example of the present disclosure.

FIG. 15A and FIG. 15B illustrate an example flowchart illustrating operations associated with a wire assembly according to another example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present disclosure will now be described more fully hereinafter with reference to the accompanying drawings, in which some, but not all examples of the disclosure are shown. Indeed, various examples of the disclosure may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the disclosure. Moreover, the term “exemplary”, as used herein, is not provided to convey any qualitative assessment, but instead merely to convey an illustration of an example. The terms “add,” “attached,” and similar terms may be used interchangeably. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As defined herein a “fiber optic,” which refers to a medium through which a signal travels over a long distance, such as light. A fiber optic may be a flexible glass, plastic, or any other suitable fiber that is configured to transmit light form one end to the other.

As defined herein a “mode field diameter” or “MFD,” may refer to the diameter of light that may pass through the termination of a fiber optic and be channeled into a waveguide or in more simpler terms the fiber optic core size, wherein the MFD is the diameter at which the intensity of light in the fiber optic falls to some specified fraction of maximum. The mode field diameter is the diameter of light that is coming out from the core of the fiber optic, wherein the MFD may be larger than the fiber optic core diameter as some level of light leakage may leak into the cladding surrounding the fiber optic core.

As defined herein a “potential difference” may refer to the electric potential energy between two points. Electric potential energy is the energy required to move a charged particle from one point to another against an electric field. The greater the potential difference between the two points, the more electric potential energy the particle will possess.

It is to be understood that the methods and systems described herein are not limited to specific methods, specific components, or to particular implementations. It is also to be understood that the terminology used herein is for the purpose of describing particular examples only and is not intended to be limiting.

Data centers are becoming the backbone of modern computing, supporting a vast array of applications and services that drive global communication, commerce, and innovation. In some examples, these facilities may be used by tech giants, cloud providers, enterprises, or the like to store, process, and distribute enormous amounts of data, enabling cloud computing, social media, e-commerce, online search, and big data analytics. As such, data centers may require high-speed data transmission and an efficient network infrastructure.

In examples, data centers may utilize fiber optics to transmit data from one or more network devices associated with a data center. Fiber optics, which may transmit data as light signals, may be integral to achieving the goals of high-speed data transmission and efficient network infrastructure of data centers. Fiber optics, in many examples, may be associated with high bandwidth and long transmission distances. One critical component of fiber optic technology may be the waveguide coupler. The waveguide coupler may play a major role in managing light signals within a fiber optic network.

Fiber optic waveguide couplers (also referred to herein as fiber optic waveguide couples or waveguide couples) are devices that may split or combine light signals within fiber optics. In an example, waveguide couples are devices that may split or combine light within fiber optics. Waveguide couples may direct light from one fiber to another, which may enable efficient data routing and distribution. In an example, waveguide couples may work by manipulating light waves within a fiber optic, thus ensuring minimal light loss, and maintaining high data integrity.

However, alignment of the fiber optics may be a significant challenge for optimal function light propagation via fiber optic waveguide couples. Proper alignment and propagation of light via interactions between a fiber optic and waveguide into the photonic integrated circuit (PIC) may allow for improved signal transmission between one or more fiber optic, one or more network devices, or the like. In such systems, the fiber optic may be the medium through which the signal travels over a long distance and waveguide may be the conduit that couples the light from the fiber optic and channels the light into the PIC. Proper alignment of optical waveguides may minimize light loss and ensure efficient signal transmission. In some examples, fiber optic waveguide couples are aligned in the following ways: active alignment or passive alignment.

Active alignment may allow for a lowest achievable light loss associated with light coupling. In systems utilizing active alignment, each fiber optic is manually adjusted with respect to the waveguide to achieve optimal light coupling and minimal light loss. However, due to the need for manual adjustment of each fiber optic, the alignment process can be time-consuming and impractical for high-volume manufacturing.

When compared to systems utilizing active alignment, systems utilizing passive alignment may allow high light loss, but the simplicity associated with passive alignment may allow for high volume manufacture of such systems. In systems where the fiber optic is passively aligned, the fiber optics are placed in a set area, cavity, or dimension, which may be done by a machine, thus this method may allow for high volume manufacturing. The high light loss associated with passive alignment may lead to negative impacts on data transfer in different scenarios, such as in a data center. In examples, the high light loss and affected data transferred may require further amplifications of the signal to provide efficient data transfer.

The light loss in fiber optics may occur due to absorption, scattering, or bending losses. Waveguide couples may help mitigate these losses by precisely controlling the light path and reducing the impact of these factors. However, the some passive and active alignment methods may be insufficient for many systems that may transfer data, such as data centers. As such, there may be a need for a more efficient system or method to reduce light loss in fiber optics caused by the alignment of fiber optic waveguide couples.

The present disclosure may be directed to systems and methods for a fiber optic assembly (e.g., generally the fiber optic assembly may be an wire assembly) that may control the model field diameter (MFD) associated with fiber optics. Examples of the present disclosure may include fiber optics that may include a fiber optic core that includes a transparent layer, a copper layer, a conductive electrode layer, or a crystal layer. The fiber optic core may be configured to direct (e.g., propagate) light to a waveguide. The fiber optic assembly may be configured to control the MFD of the light at the termination of the fiber (e.g., end of the fiber optic), via liquid crystal layer, which may optimize light coupling into the waveguide.

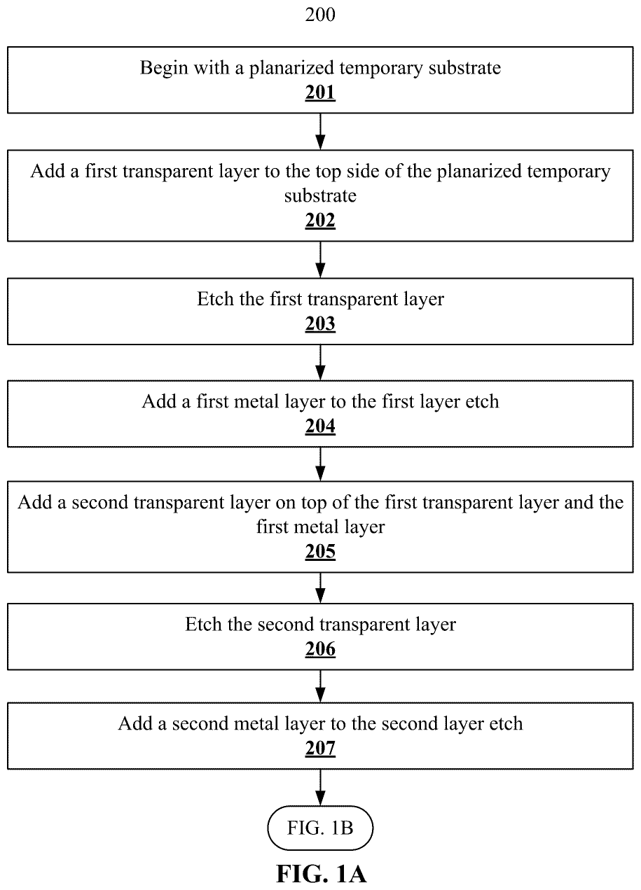

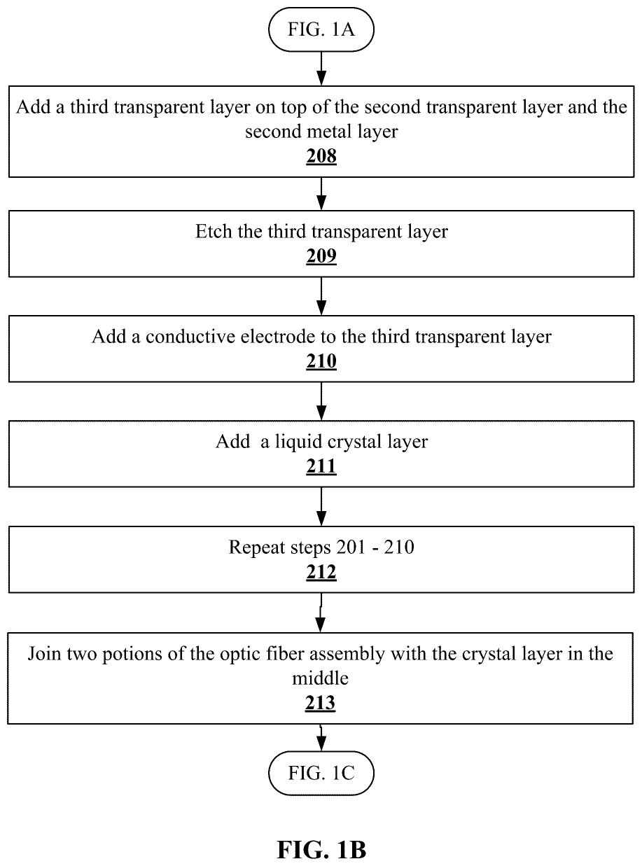

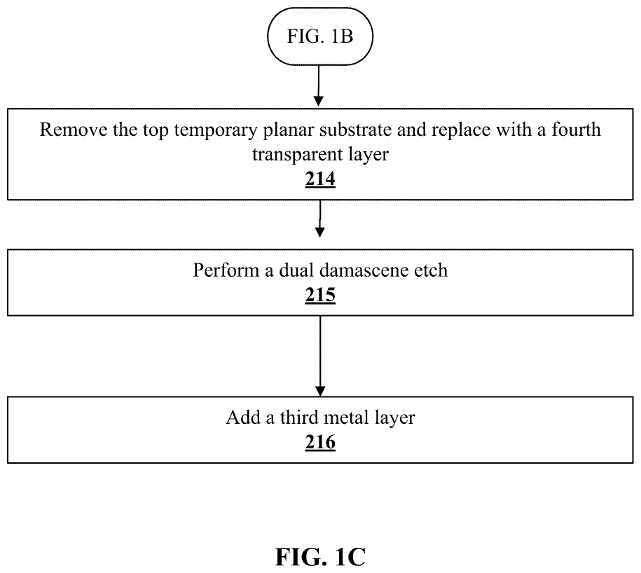

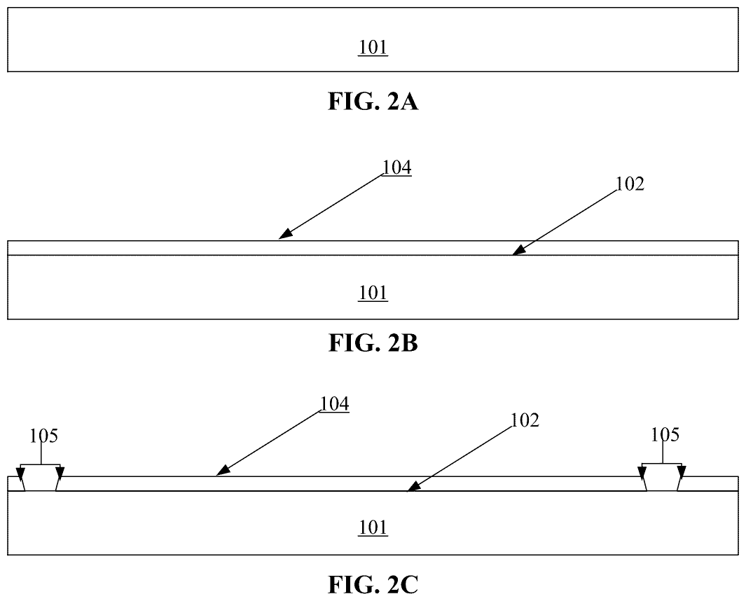

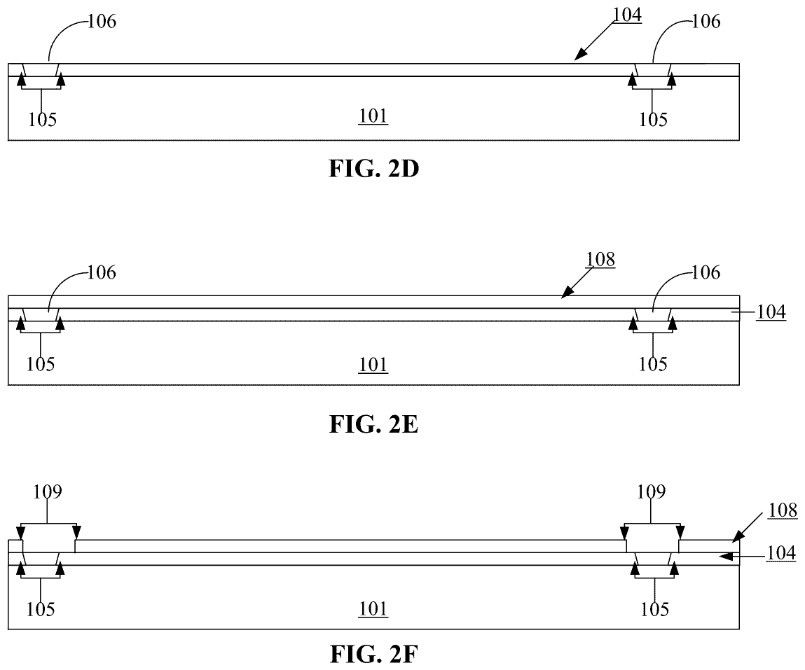

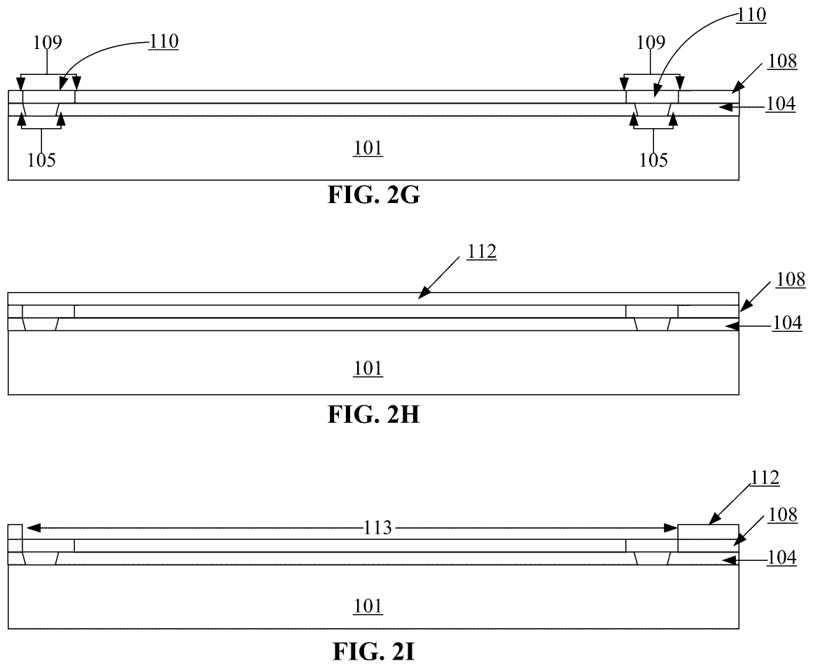

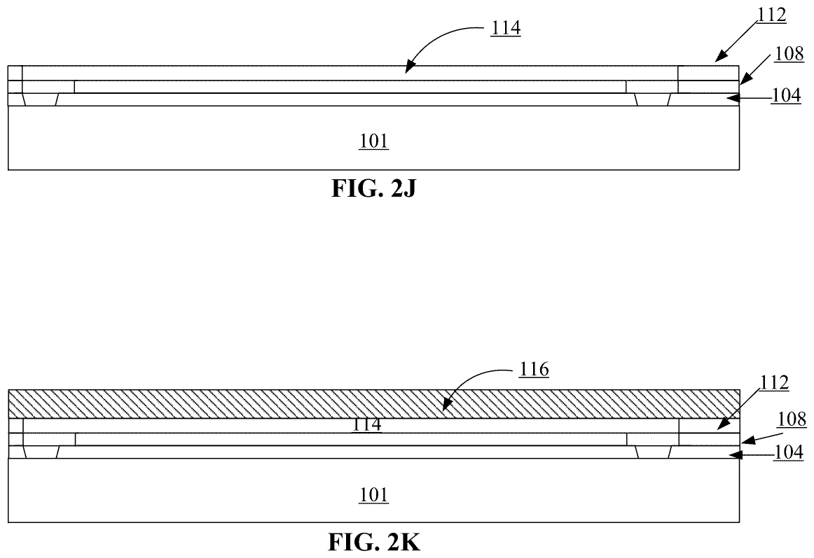

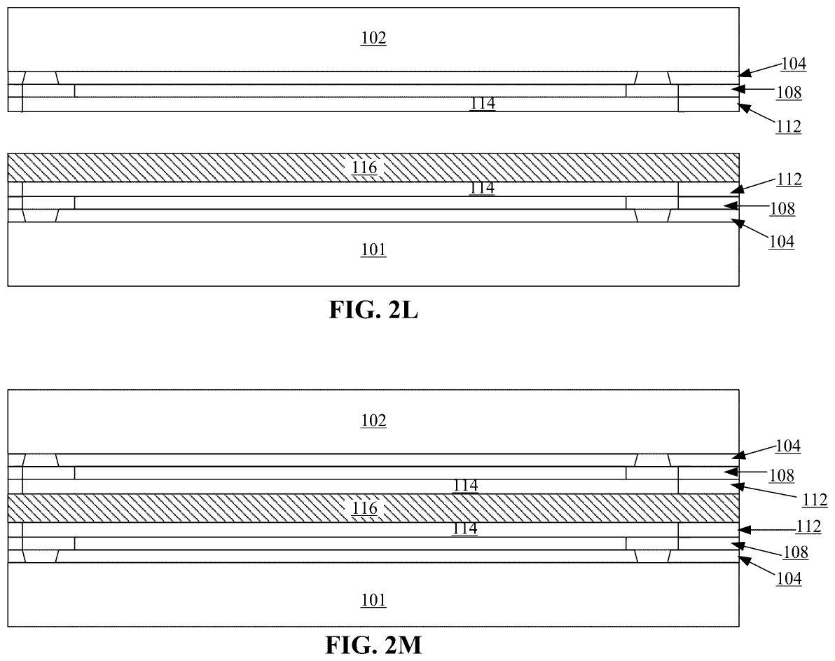

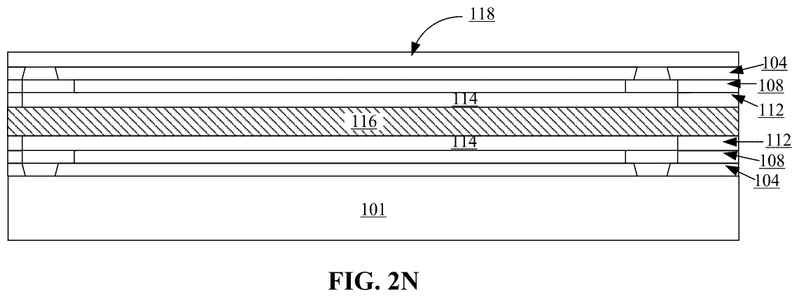

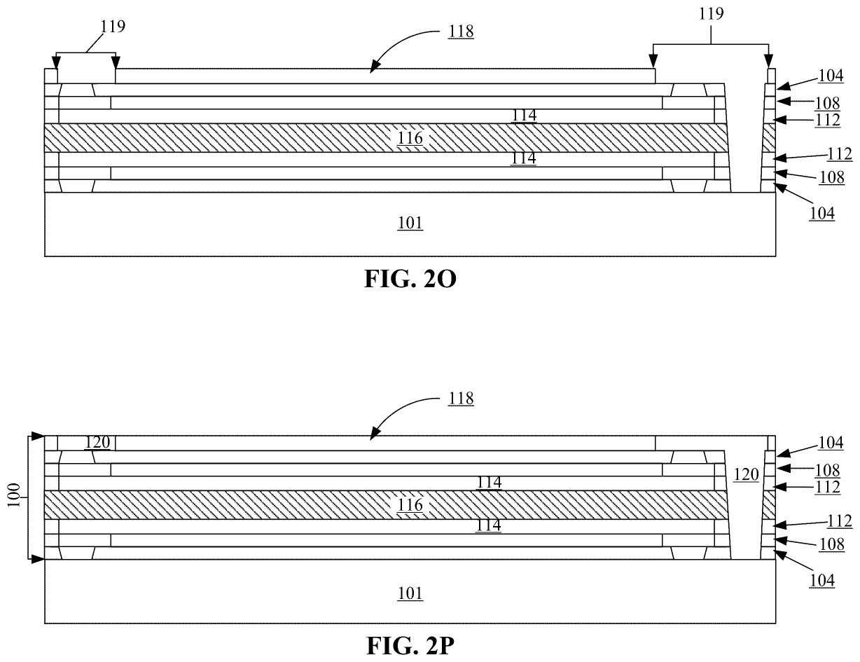

FIGS. 2A, 2B, 2C, 2D, 2E, 2F, 2G, 2H, 2I, 2J, 2K, 2L, 2M, 2N, 2O, and 2P are an illustrative cross-sectional view of the layers of a fiber optic assembly 100, according to an example of the present disclosure. The FIGS. 2A, 2B, 2C, 2D, 2E, 2F, 2G, 2H, 2I, 2J, 2K, 2L, 2M, 2N, 2O, and 2P are different portions of what may comprise a fiber optic assembly 100. The method 200 of FIG. 1 incorporates the illustrations of FIGS. 2A, 2B, 2C, 2D, 2E, 2F, 2G, 2H, 2I, 2J, 2K, 2L, 2M, 2N, 2O, and 2P for further explanation.

FIG. 1A, FIG. 1B and FIG. 1C illustrates an example method 200 in the context of adding layers as shown in FIGS. 2A, 2B, 2C, 2D, 2E, 2F, 2G, 2H, 2I, 2J, 2K, 2L, 2M, 2N, 2O, and 2P for an assembly, such as a fiber optic assembly 100. The fiber optic assembly 100 may be positioned terminally at the end of a fiber optic 250 to facilitate interactions between the fiber optic 250 and the waveguide 310. At step 201 with reference to FIG. 2A, there may be a temporary planar substrate 101, which may be silicon, quartz, or any other suitable material with a low coefficient of thermal expansion to prevent bowing or flexing. At step 202 with reference to FIG. 2B, a first transparent layer 104 (e.g., transparent coating) may be added to the top side 102 of the planarized temporary planar substrate 101, ensuring the refractive index matches that of the fiber optic core 255. The first transparent layer 104 may be applied through spin coating, sputter coating, or any other suitable method. The first transparent layer 104 may be of a known refractive index. The refractive index of the first transparent layer 104 may be matched with refractive index of the fiber optic core 255. At step 203 with reference to FIG. 2C, the first transparent layer 104 may be etched. The first transparent layer 104 may be etched to create a first layer etch 105. The first layer etch 105 may be created via laser etching, UV lithography, DUV lithography, EUV lithography, or any other method depending on the desired dimension of the MFD.

At step 204 with reference to FIG. 2D, a first electrically conductive material (e.g., copper layer or other metal) to the etched portions (e.g., first layer etch 105) of the first transparent layer 104 may be added. The first electrically conductive material may be discussed herein as a first metal layer 106. At step 205 with reference to FIG. 2E, a second transparent layer 108 may be added with a refractive index matching that of the first transparent layer 104, which may position it on top of the first transparent layer and the first metal layer 106. The second transparent layer 108 may be positioned on top of the first transparent layer 104 and the etched in first metal layer 106. The second transparent layer 108 may be applied through spin coating, sputter coating, or any other suitable method. At step 206 with reference to FIG. 2F, a second layer etch 109 may be performed on the second transparent layer 108, similar to step 203.

At step 207 with reference to FIG. 2G (which is similar to step 204), a second electrically conductive material (e.g., copper layer or other metal) may be added to the etched portion (e.g., second layer etch 109) of the second transparent layer 108. The second electrically conductive material (e.g., second metal layer 110) may be chemically and mechanically polished to achieve surface uniformity. In some examples, the second metal layer 110 that may be added to the second layer etch 109 of the second transparent layer 108 of step 207 may be chemically and mechanically polished (CMP'd) to achieve surface uniformity and to reduce waviness and roughness across the surface of this layer. Surface uniformity may refer to a uniform height of peaks and valleys on the surface of a material. At step 208 with reference to FIG. 2H, a third transparent layer 112 may be added on top of the second transparent layer and the etched second metal layer 110, ensuring the refractive index of the third transparent layer 112 matches the first transparent layer 104 and second transparent layer 108. The third transparent layer 112 may be added to the fiber optic assembly 100 on top of the second transparent layer 108 and second metal layer 110, wherein the refractive index of the third transparent layer 112 may be identical or match the first transparent layer 104 and second transparent layer 108. At step 209 with reference to FIG. 2I, etch the third transparent layer 112, creating a third layer etch 113.

At step 210 with reference to FIG. 2J, a conductive electrode layer 114 may be added to the third transparent layer 112 associated with the etched portion (e.g., third layer etch 113) of the third transparent layer 112. The conductive electrode layer 114 may be configured to act as a medium which may cause or determine a potential difference between points. The potential difference may allow for changes in orientation of the liquid crystal layer 116. In some examples the conductive electrode layer 114 may be transparent. The conductive electrode layer 114 may be indium tin oxide or any other conductive transparent electrode layer. The conductive electrode layer 114 may be positively or negatively charged. At step 211 with reference to FIG. 2K, a liquid crystal layer 116 may be added on top of the third transparent layer 112 and the conductive electrode layer 114, using suitable liquid crystals. The liquid crystal layer 116 may be comprised of pneumatic cholesteric, or any other suitable liquid crystals. In some examples, the liquid crystals, associated with the liquid crystal layer 116, in the fiber optic assembly 100 may be mixed and matched. For example, the liquid crystal layer 116 may include pneumatic or cholesteric liquid crystals.

At step 212, with reference to FIG. 2L, the steps 201-210 may be repeated for another portion (e.g., another half) of the fiber optic assembly 100. At step 213 with reference to FIG. 2M, the two portions of the fiber optic assembly 100 may be joined with the liquid crystal layer 116 in the middle of the transparent layers (e.g., third transparent layer 112 and conductive electrode layer 114 of the two portions of the fiber optic assembly 100). The two conductive electrode layers 114 may be referred to herein as electrode layers 114. At step 214 with reference to FIG. 2N, remove the top temporary planar substrate and replace it with a fourth transparent layer 118 of known refractive index matching the other transparent layers (e.g., first transparent layer 104, second transparent layer 108, or third transparent layer 112). In an example, the temporary planar substrate (e.g., temporary planar substrate 101) may be removed via lasers, heating, or any other suitable process.

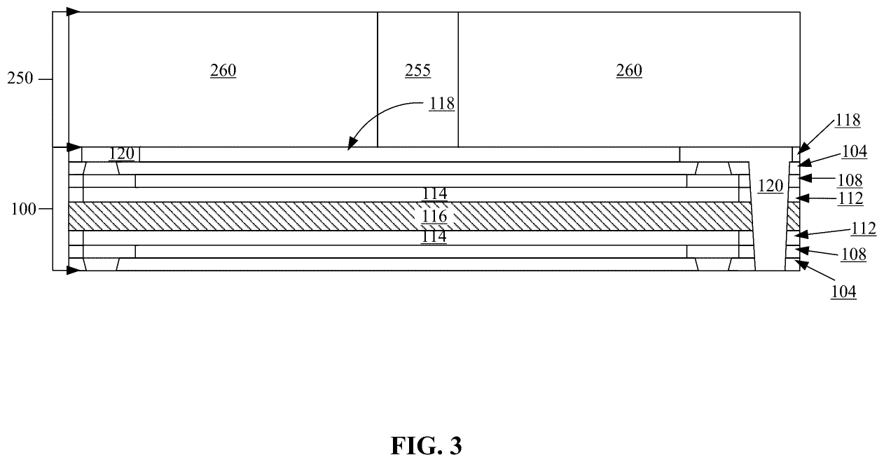

At step 215 with reference to FIG. 20, perform a dual damascene etch 119 (or other multilayer etch process) for a fourth electrically conductive material layer (e.g., a third metal layer 120), configured to allow contact with the first electrically conductive material layer (e.g., first metal layer 106) of the fiber optic assembly 100 and a photonic integrated circuit 305, which may be approximately at the same time. The dual damascene etch 119 may be created such that it is possible to reach from one side of the assembly to another. For example, dual damascene etch 119 may be in contact with the temporary planar substrate 101 and the surface of the fiber optic assembly 100. At step 216, with reference to FIG. 2P, a third metal layer 120 may be configured to fit into the damascene etch 119 of step 215. At step 216, the one or more transparent layers (e.g., first transparent layer 104, second transparent layer 108, third transparent layer 112, or fourth transparent layer 118), one or more electrically conductive layers (e.g., first metal layer 106, second metal layer 110, or third metal layer 120), one or more conductive electrode layers (e.g., conductive electrode layer 114), and the liquid crystal layer 116 may constitute a fiber optic assembly 100. In operation, for example, positive and negative signals may be received and transmitted through the fiber optic assembly 100. FIG. 3 may illustrate an attachment of the fiber optic assembly 100 to a fiber optic 250, at a terminal end of the fiber optic 250.

It is to be understood that the steps the method 200 of FIG. 1 may be altered in any suitable order or may require less or more steps. It is contemplated that any number of layers (transparent layers, metal layers, etched layers, electrode layers, or liquid crystal layers) may be present in the fiber optic assembly 100, which would be readily apparent by one skilled in the art.

FIG. 3 is an illustrative cross-sectional side view of a fiber optic 250 attachment with the fiber optic assembly 100, according to an example of the present disclosure. A fiber optic 250 may now be attached to the fiber optic assembly 100. The fiber optic 250 may be attached to the end of the fiber optic assembly 100 associated with the fourth transparent layer 118 and the third electrically conductive material layer (e.g., third metal layer 120). The connection or contact between the one or more electrically conductive layers (e.g., first metal layer 106, second metal layer 110, or third metal layer 120) of fiber optic assembly 100 may be referred to herein as an electrically conductive stack or a metal stack. The fiber optic 250 may be attached hermetically on top of the upper layer (e.g., fourth transparent layer 118 and third metal layer 120) of the fiber optic assembly 100 of steps 213-216. The fiber optic 250 may comprise of a fiber optic core 255 and cladding 260. The fiber optic core 255 may be the part of the fiber optic 250 that guides the light. The fiber optic core 255 may be a cylinder of glass or plastic that runs along the length of the fiber optic 250. The fiber optic core 255 may be surrounded by a medium with a lower index of refraction, typically a cladding 260 of a different glass, or plastic. Light travelling in the fiber optic core 255 reflects from the core-cladding (e.g., cladding 260) boundary due to total internal reflection, as long as the angle between the light and the boundary is greater than the critical angle. As a result, the fiber optic 250 may transmit light rays that enter the fiber optic 250 with a sufficiently small angle to the fiber optic 250 axis, wherein the limiting angle may be called the acceptance angle, and the light rays that are confined by the fiber optic core 255 or cladding 260 boundary may be called guided rays.

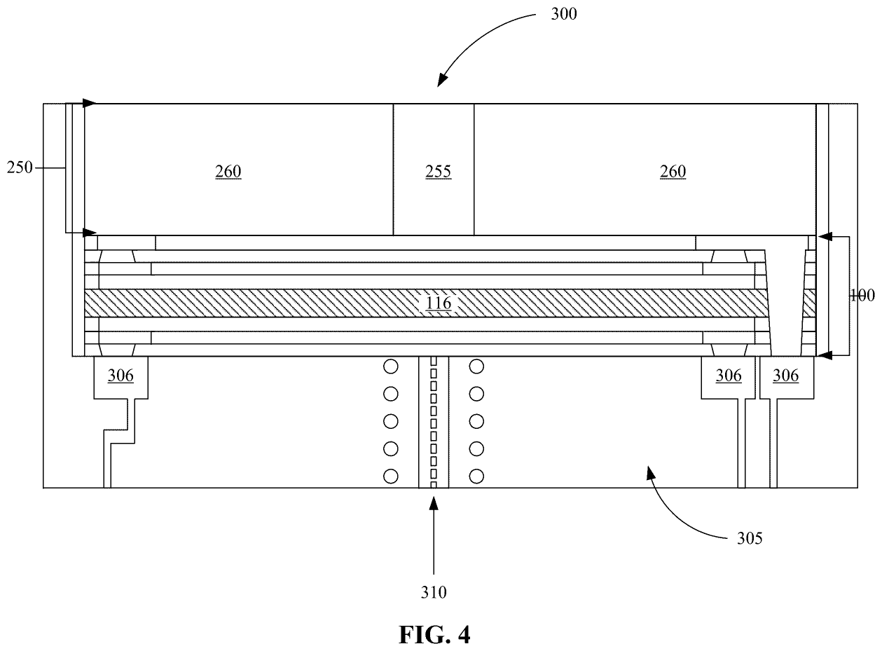

FIG. 4 is a cross-sectional side view of a fiber optic 250 and waveguide couple 300, according to an example of the present disclosure. The system may now attach the combination of the fiber optic 250 and fiber optic assembly 100 to a photonic integrated circuit 305 comprising a waveguide 310. Prior to the attachment of the fiber optic 250 and fiber optic assembly 100 as shown in FIG. 3 may be attached to the photonic integrated circuit 305, the remaining temporary planar substrate 101 as shown in FIG. 3 may be removed. As such, the end of the fiber optic assembly 100, associated with the removal of the temporary planar substrate 101, may be aligned to a photonic integrated circuit 305 (e.g., waveguide 310). The fiber optic 250 and fiber optic assembly 100 as shown in FIG. 3 may be aligned to the photonic integrated circuit 305 (e.g., waveguide 310) using methods associated with systems that may utilize passive alignment. The passive alignment of the fiber optic 250 and fiber optic assembly 100 may comprise the placement (e.g., alignment) of the fiber optic 250 and fiber optic assembly 100 in a v-groove (or any other suitable grove) associated with a photonic integrated circuit (PIC) 305. In some examples, the PIC 305 may be configured to have interconnection sites 306 associated with the one or more metal layers (e.g., first metal layer 106) and one or more metal stacks (e.g., the first metal layer 106, the second metal layer 110, and the third metal layer 120) associated with fiber optic assembly 100. The interconnection sites 306 may be configured such that the PIC 305 may provide electrical signals to the liquid crystal layer 116 via the electrically conductive material layers (e.g., first metal layer 106, second metal layer 110, or the third metal layer 120) of the fiber optic assembly 100. In an example, the electrical signals may adjust the potential difference between the electrode layers (e.g., conductive electrode layer 114) located on opposite sides of the liquid crystal layer 116. The molecules of the liquid crystal layer 116 may be configured to change orientation or direction depending on the electrical signals received via the electrode layers 114. In some examples, to ensure that the metal lines, illustrated with interconnection sites 306, associated with PIC 305 and fiber optic assembly 100 are making contact with the corresponding interconnection sites 306, bonding may be performed using methods such as thermosonic bonding, solder-pump processed or any other suitable bonding process. In an example, the PIC 305 may be configured to provide the electrical signals itself. In an example, the fiber optic core 255 associated with the fiber optic 250 may be configured to align with a waveguide 310 associated with the PIC 305.

As shown in FIG. 4, the diameter of the waveguide 310 may be smaller than the MFD associated with the fiber optic core 255, which may lead to significant light leakage resulting in increased temperature and a lower quality of light or data transmission in conventional or known systems. With the use of the fiber optic assembly 100, the MFD may remain the same as in some other systems. The electrode layer 114 of the fiber optic assembly 100, as disclosed herein, may be configured to provide an optimized position, via potential difference, of liquid crystal molecules, associated with the liquid crystal layer 116, based on the light loss observed. As such, the liquid crystal molecule positions or orientations may be changed based on a perceived light loss determined by the PIC 305. Liquid crystal molecule position may refer to the spatial arrangement and orientation of molecules within the liquid crystal layer 116. Liquid crystal molecule orientation may refer to the direction in which the long axes of molecules are aligned or facing. In some examples, the liquid crystal molecules may be deposited into the liquid crystal layer at a set orientation considered or referred to as a time zero position. Based on the potential difference between the electrical signals applied to the electrode layers 114 on either side of the liquid crystal layer 116 the molecules of the liquid crystal layer 116 may be adjusted such that the liquid crystal layer 116 may direct light, introduced to the fiber optic assembly 100 via fiber optic core 255. The molecules associated with the liquid crystal layer 116 may be changed or altered to direct a maximum amount of light to the waveguide 310 of PIC 305, with negligible light leakage. In an example, the potential difference between the electrode layers 114 positioned on opposite sides of the liquid crystal layer 116 may initiate a change in orientation or position of the molecules of the liquid crystal layer 116. The change in orientation may include one or more of a rotation, turn, or any other suitable movement of molecules, or any combination thereof.

In an example of operation, the fiber optic 250 may direct a signal (e.g., data, light, or the like) to a waveguide 310 associated with the PIC 305. Generally, the signal may be directed within the fiber optic core 255. The PIC 305 may receive a leakage associated with the signal. The PIC 305 may determine a potential difference between the PIC 305 and the fiber optic assembly 100. The PIC 305 may transmit a message comprising the potential difference to a device to adjust the electrical signal at the PIC 305 such that the charge at the interconnection site 306 may reflect the adjustment needed for the signal to be received with the leakage mitigated. Based on the potential difference, one or more molecules associated with a liquid crystal layer 116 may be adjusted.

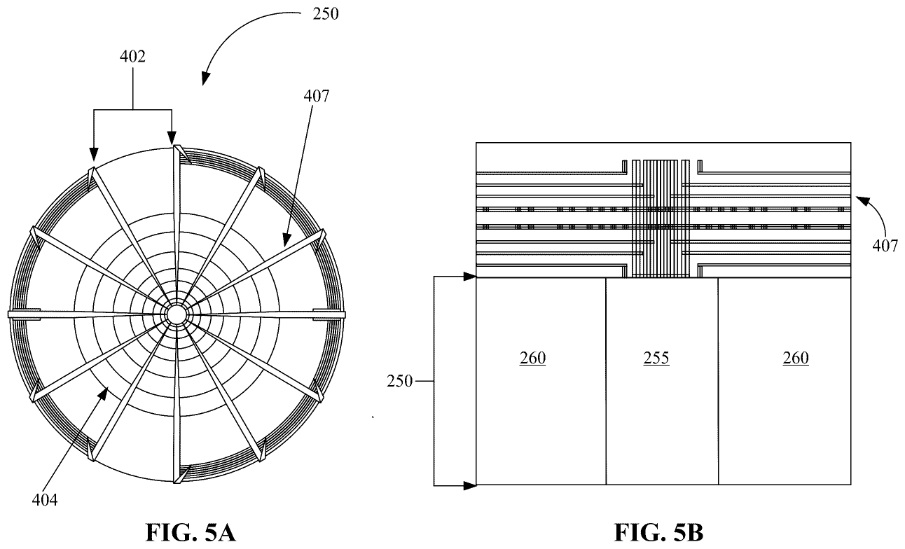

FIG. 5A is a top-down view of a fiber optic 250 (e.g., viewing along the diameter of the fiber optic 250, where a fiber optic assembly 100 may be attached to the terminal end of the fiber optic 250. In view of FIG. 5A, the terminal end of the fiber optic 250 is illustrated, according to an example of the present disclosure. FIG. 5B illustrates a cross-sectional view of a fiber optic 250 and fiber optic assembly 100 attachment associated with the terminal end of the fiber optic 250, according to an example of the present disclosure. Referring to FIG. 5A, due to the nature of the light passing through the fiber optic 250 the shape of light received (e.g., passing through) the fiber optic 250 may be of any conceivable shape constrained within the MFD of the fiber optic 250. In an example, the fiber optic assembly 100 may be sectioned one or more times to compensate for the free-form nature of the light passing through the MFD of the fiber optic 250, wherein these sections 402 may be determined by the lines radiating from the center of the fiber optic core 255 to the outside of the fiber optic 250. In an example, the fiber optic assembly 100 may be constructed to have multiple rings 404 of the fiber optic assembly 100 described in FIG. 1 as well as sections 402 to capture various shapes or direction of the light passing through the MFD of the fiber optic 250. It is contemplated that the fiber optic 250 may comprise any suitable number of sections 402 or rings 404 that are suitable for the system at which the fiber optic 250 may be connected, such as a data center. The lines that are depicted radially on the fiber optic 250 may be representative of the electrically conductive material layers 407.

With continued reference to FIG. 5A, the electrically conductive material layers 407 as illustrated may include one or more of the first metal layer 106, the second metal layer 110, or the third metal layer 120 as illustrated with FIG. 1 and discussed in the method 200 of FIG. 1. It is contemplated that there may be any number of electrically conductive material layers 407 such that light leakage or light loss may be limited, wherein the number of electrically conductive material layers 407 may be determined based on the system and the wavelength of light expected in the system. In an example, the electrically conductive material layers 407 associated with one side (e.g., a left side) of the fiber optic assembly 100 may be positive in charge and the other side (e.g., a right side) may be negative in charge, where the side charged positively and negatively may be controlled individually. In an example, the rings 404 or sections 402 may be configured to be controlled individually based on the electrical charge received via interaction between PIC 305 and fiber optic 250. As such, one or more sections 402 or rings 404 may be individually controlled depending on the region (e.g., area) where more light may be scattering away from the waveguide 310 as illustrated in FIG. 4. For example, if more light is scattering on the left side of the fiber optic 250, the sections 402 or rings 404 associated with the left side of the fiber optic 250 may be individually controlled and optimized to direct the light towards the waveguide 310, via liquid crystal layer 116, compared to the right side of the fiber optic 250. It is to be contemplated that the fiber optic assembly 100 may include any number of sections 402 or rings 404. Now referring to FIG. 5B that illustrates a cross-sectional side view of a fiber optic 250 and fiber optic assembly 100. The bottom portion of the FIG. 5B is the fiber optic 250 and at the top portion is a simplified illustration to show the electrically conductive material layers 407 of the fiber optic assembly 100 at the fiber optic core 255 or MFD of the fiber optic 250. In an example, each one of the electrically conductive material layers 407 may connect to one or more sections 402 or rings 404 of FIG. 5A, corresponding to the configuration of one or more sections 402 or ring 404 configured to be controlled individually. The electrically conductive material layers 407 depicted may align in the same position connecting to the PIC 305, where the potential difference associated with the fiber optic assembly 100 may be observed in respect to the light received (e.g., the light passing through the MFD (e.g., fiber optic core 255)). It is contemplated that there may be any design of electrically conductive material layers 407 such that they may be configured to attach or communicate with the PIC 305, via interconnection sites 306.

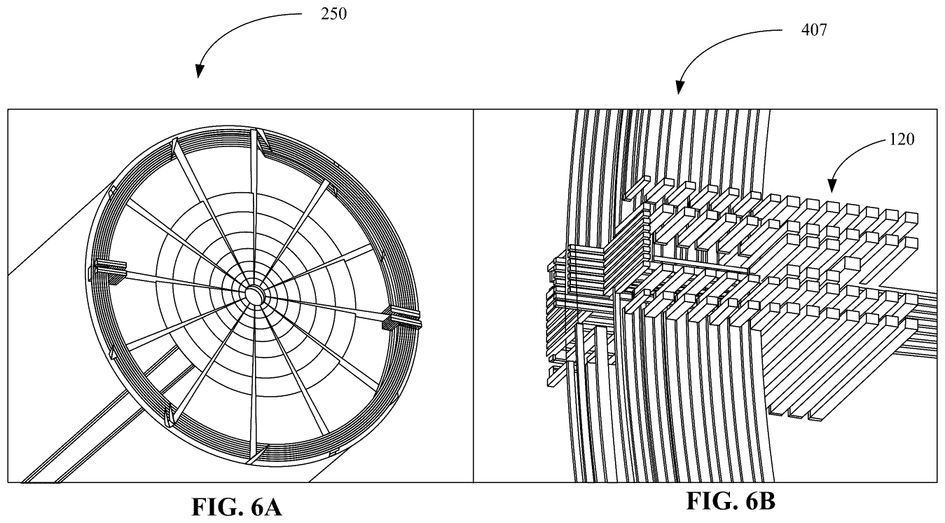

FIG. 6A is an illustrative view of the fiber optic assembly 100 associated with the terminal end of a fiber optic 250. FIG. 6B illustrates a simplified view of the electrically conductive material layers 407 of the fiber optic assembly 100 associated with the outer portion of the fiber optic 250 (e.g., away from the fiber optic core 255). As illustrated, the protruding or horizontal rectangular objects may illustrate the third metal layer 120 of the fiber optic assembly 100. It is contemplated that there may be any suitable number of electrically conductive material layers 407 suitable for the system at which the fiber optic 250 and fiber optic assembly 100 may be aligned (e.g., attached).

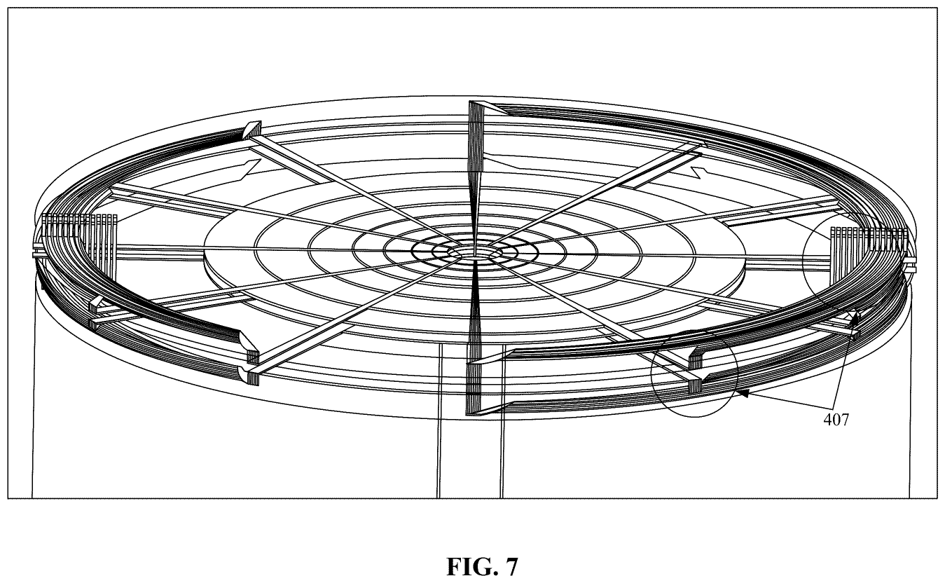

FIG. 7 is a side view of the terminal end of a fiber optic 250, according to an example of the present disclosure. In the illustration of FIG. 7, it may be possible to see the electrically conductive material layers 407 layers of FIG. 5B and FIG. 6B.

In an example, the process of light passing through the MFD to the PIC 305 may comprise an active feedback loop to assess or constantly change based on the free-form nature of light passing through the MFD associated with the fiber optic core 255. The shape of the light may vary at any increment of time; therefore, the PIC 305 circuitry may be configured to determine changes in the shape of the received light, which may correspond to the sections 402 or rings 404 ability to be individually controlled.

In an example, the configuration of the fiber optic assembly 100 may aid in temperature fluctuation compensation. For example, a fiber optic 250 may be aligned to a waveguide 310, where there is temperature fluctuation initiated by, for example, a high workload (e.g., high rate or number of data being transferred). The high workload may result in a large amount of heat being generated; therefore, fans may blow at high speeds. The high temperature experienced may cause expansion or contraction of the fiber optic 250 based on the material being used. As the temperature fluctuates due to the use of fans to cool the system that is experiencing a high temperature due to an increased or high workload, the position of the fiber optic 250 (e.g., more specifically the fiber optic core 255) in respect to the waveguide 310 may move slightly in any direction. Conventionally, using modern alignment techniques or methods, the slightest change in alignment may result in considerable light loss. However, in the example of the present disclosure, the fiber optic assembly 100 in conjunction with the active feedback loop may direct the light to the proper position to be directed to the waveguide 310. The light may be directed to the waveguide 310 due to a change in potential difference determined with the movement of the fiber optic 250 in respect to the waveguide 310. As a result, the orientation or direction of the molecules associated with the liquid crystal layer 116 may be changed (e.g., adjusted) to compensate for the movement of the fiber optic 250 alignment to the waveguide 310. For example, if the fiber optic 250 has moved up relative to the waveguide 310, the majority of light may pass above the waveguide 310. As such, the active feedback mechanism of the PIC 305 may communicate with the fiber optic assembly 100 to direct the light (e.g., direct light down) to the region where the waveguide 310 to mitigate light leakage. In an example, the PIC 305 may activate one or more rings 404 or sections 402 separately to determine the areas (e.g., regions) where light is maximum, where depending on which of the sections 402 or rings 404 are receiving maximum light the PIC 305 may alter its charge to change the potential difference to a value that may change the orientation or direction of liquid crystal molecules associated with the liquid crystal layer 116 such that those rings 404 or sections 402 of the fiber optic assembly 100 are active and directing light in a direction relative to the waveguide 310.

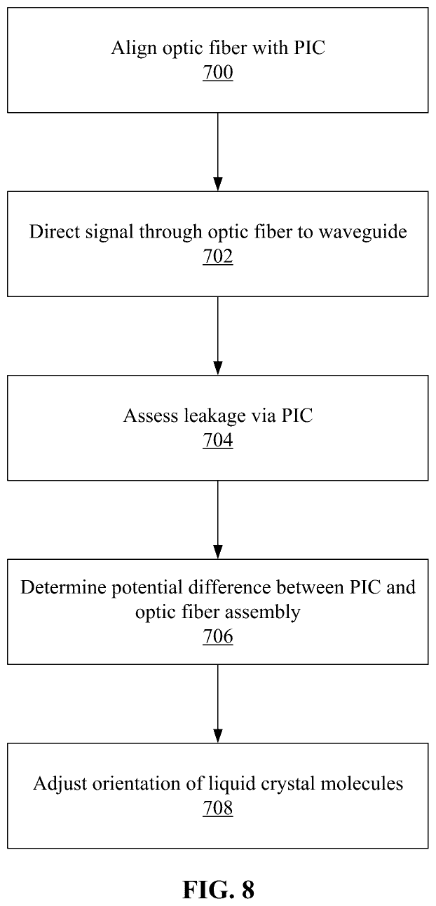

FIG. 8 illustrates an example method flow illustrating operations of reflecting rays of light via fiber optic 250 to a waveguide 310 associated with a PIC 305. At step 700, a fiber optic 250 comprising a fiber optic assembly 100 may be aligned with a waveguide 310 associated with a PIC 305 via passive alignment methods. For example, the fiber optic 250 may be aligned via v-grooves associated with PIC 305 and waveguide 310. At step 702, a device (e.g., data center, artificial reality system 900, broadcasting system, networking system, data transferring systems, or any suitable system) may direct signals (e.g., light, data, information, or the like) via fiber optic core 255, which may propagate the signal via MFD, to a waveguide 310. The signal may first pass through a fiber optic assembly 100 positioned at the terminal end of the fiber optic 250 and aligned in the PIC 305.

At step 704, PIC 305 may assess the signals leakage via interconnection sites 306. Signal leakage may be assessed based on the electrical signal being received at the interconnection sites 306, resulting in an electrical charge being determined at the interconnection sites 306 which may be propagated or transferred to a electrode layer 114 positioned on one side of the liquid crystal layer associated with the fiber optic assembly 100. In an example, the charge at the interconnection sites 306 associated with PIC 305 may be determined or created via interactions or an electrical coupling between PIC 305 and a device, such as but not limited to, a head mounted display (e.g., HMD 800), one or more network devices (e.g., one or more network devices 720), one or more communication devices (e.g., communication devices 711, 712, 713). At step 706, a potential difference between the electrode layers 114 positioned on both sides of the liquid crystal layer 116 may be determined. One electrode layer may be charged positively or negatively based on the light received directly from the fiber optic core 255 or MFD. The electrode layer 114 positioned on the opposite side of the liquid crystal layer 116 may be positively or negatively charged based on the charge at the interconnection sites 306 associated with the PIC 305.

At step 708, the molecules of the liquid crystal layer 116 may be adjusted based on the potential difference to allow for the signal being guided to the waveguide 310 to reach a maximum, which may be determined by the system or via manufacturing. For example, the molecules of the liquid crystal layer 116 may be rotated 90 degrees to direct more light, data, signal, or the like to waveguide 310. In an example, steps 704 through 708 may be on an active or positive feedback loop, wherein the potential difference may change at any increment of time (e.g., nanosecond, millisecond, second, or any increment of time) or whenever the shape of the signal may change.

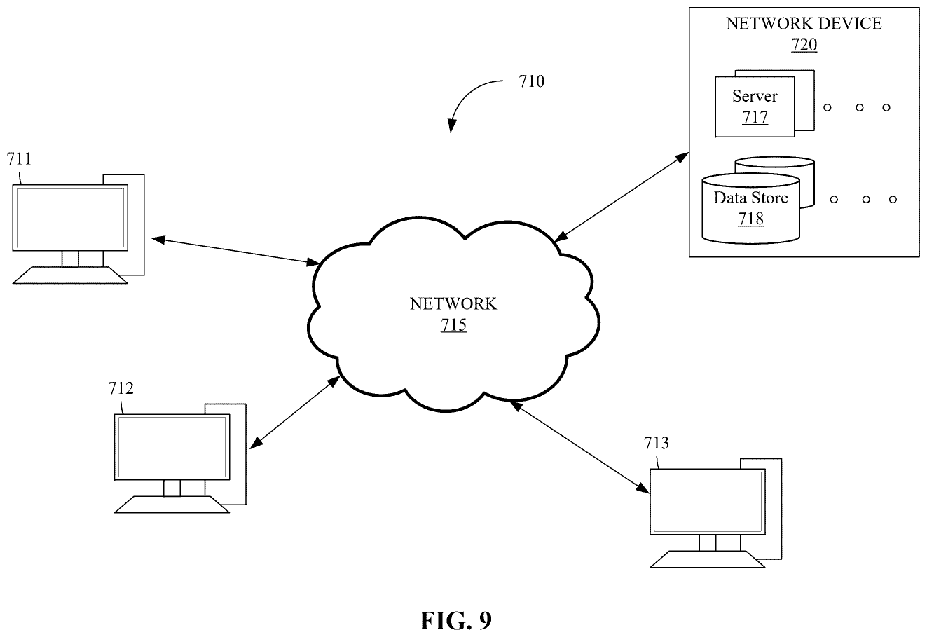

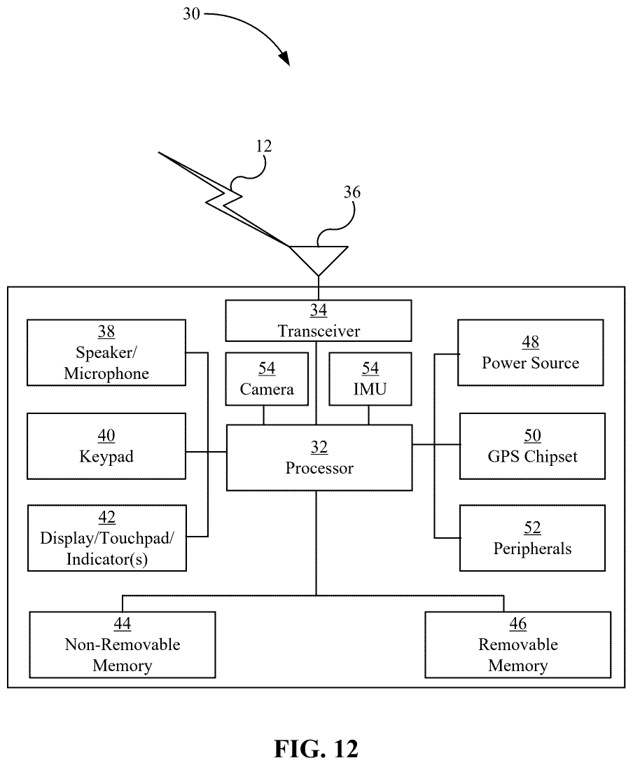

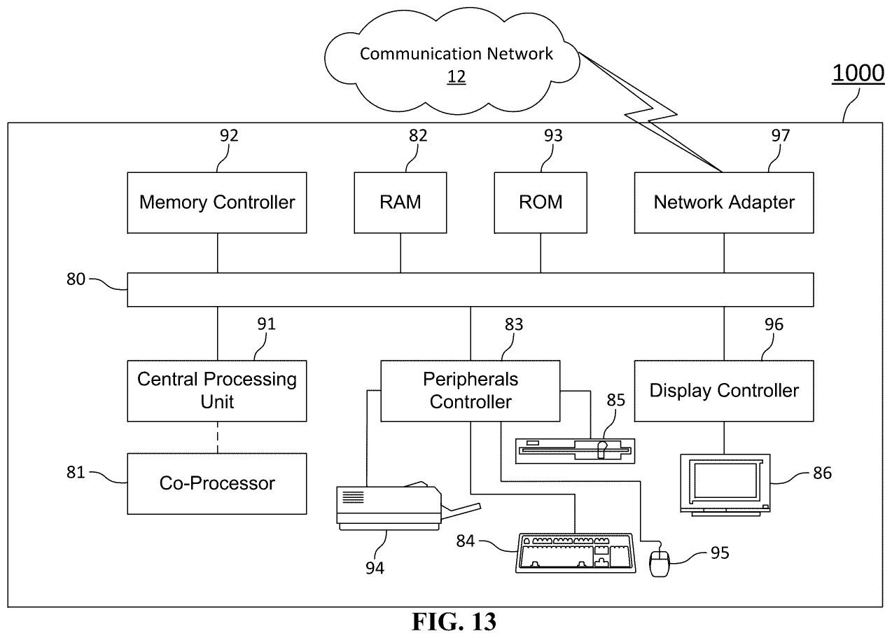

FIG. 9 illustrates an example system 710 according to example aspects of the present disclosure. The system 710 may be capable of facilitating the transmission of data among users, servers, databases, or any combination thereof. The system 710 may include one or more communication devices 711, 712, 713 (also may be referred to herein as user devices 711, 712, 713), server 717, data store 718, or network device 720. In some examples, communication devices 711, 712, and 713 may be examples of user equipment (UE) (e.g., UE 30 of FIG. 12). As shown for simplicity, network device 720 may comprise one or more servers (e.g., server 717) and one or more data stores (e.g., data store 718). In some examples, the network device 720 may be a computer system (e.g., computer system 1250 of FIG. 13) capable of delivering internet based content or other content to users over a network 716 (e.g., the internet) via a web browser. In some examples, it is contemplated that the network device 720 may be a standalone device. In other examples, the network device may be located on a server. It is contemplated that network device 720 may interact and/or communicate with one or more devices (e.g., communication devices 711, 712, 713) of system 710.

In some examples, communication device 711, communication device 712 and communication device 713 may be associated with an individual (e.g., a user), entity (e.g., organization), or the like that may interact or communicate with an application(s) or data server(s) associated with network device 720. The network device 720 may be considered, or associated with, an application(s), a messaging platform(s), a social media platform(s), and/or the like. In some examples, one or more users may use one or more devices (e.g., communication device 711, communication device 712, communication device 713) to access, send data to, and/or receive data from network device 720. In some examples, one or more entities may use one or more devices (e.g., communication device 711, communication device 712, communication device 713) to access, send data to, and/or receive data from network device 720.

This disclosure contemplates any suitable network 716. As an example and not by way of limitation, one or more portions of network 716 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 716 may include one or more networks 716.

Links 715 may connect communication device 711, communication device 712 and/or communication device 713 to network device 720 to network 716 and/or to each other. This disclosure contemplates any suitable links 715. In particular examples, one or more links 715 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 715 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 715, or a combination of two or more such links 715. Links 715 need not necessarily be the same throughout network 716 and/or system 710. One or more first links 715 may differ in one or more respects from one or more second links 715.

The communication devices 711, 712 and 713 may be an electronic device including hardware, software, or embedded logic components or a combination of two or more such components and capable of carrying out the appropriate functionalities implemented or supported by the communication devices 711, 712, 713. As an example and not by way of limitation, communication devices 711, 712, 713 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., communication devices 711, 712, 713). One or more of the communication devices 711, 712, 713 may enable a user to access network 716. One or more of the communication devices 711, 712, 713 may enable a user(s) to communicate with other users at other communication devices 711, 712, 713.

In particular examples, system 710 may include one or more servers 717. Each of the servers 717 may be a unitary server or a distributed server spanning multiple computers or multiple datacenters. Servers 717 may be of various types, such as, for example and without limitation, web server, news server, mail server, message server, advertising server, file server, application server, exchange server, database server, proxy server, another server suitable for performing functions or processes described herein, or any combination thereof. In particular examples, each of the servers 717 may include hardware, software, or embedded logic components or a combination of two or more such components for carrying out the appropriate functionalities implemented or supported by server 717.

In particular examples, system 710 may include one or more data stores 718. Data stores 718 may be used to store various types of information. In particular examples, the information stored in data stores 718 may be organized according to specific data structures. In particular examples, each of the data stores 718 may be a relational, columnar, correlation, or other suitable database. Although this disclosure describes or illustrates particular types of databases, this disclosure contemplates any suitable types of databases. Particular examples may provide interfaces that enable communication devices 711, 712, 713 or another system (e.g., a third-party system) to manage, retrieve, modify, add, or delete, the information stored in data store 718.

In some examples, network device 720 may be a network-addressable computing system that may host an online search network. The network device 720 may store, receive, process, or analyze data. In examples, network device 720 may facilitate data interactions between clients (e.g., users), databases, and entities (e.g., organizations). In an example, the network device 720 may retrieve data from data bases (e.g., data store 718) and execute data mining processes or methods to extract information associated with the data. The network device 720 may be configured to handle a vast volume of data generated from a number of sources such as but not limited to web pages, social media platforms, or the like. The network device 720 may be configured to retrieve, process, or analyze data based on a request, where in response the network device 720 may retrieve relevant data from databases (e.g., data store 718), servers (e.g., server 717), or any other device of system 710. In some examples, network device 720 may be configured to perform methods or processes associated with data mining to generate a result associated with the request received.

Although FIG. 9 illustrates a particular arrangement of communication device 711, communication device 712, communication device 713, network 716, server 717, data store 718, and/or network device 720, among other things, this disclosure contemplates any suitable arrangement. The devices of system 710 may be physically or logically co-located with each other in whole or in part.

It should be pointed out that although FIG. 9 shows one network device 720, server 717, data store 718 and three communication devices 711, 712, and 713, any suitable number of network devices 720, communication devices 711, 712, 713, servers 717, or data stores 718 may be part of the system 710 of FIG. 1 without departing from the spirit and scope of the present disclosure.

It is contemplated that although this disclosure may specifically mention data centers, the methods and systems as disclosed herein may have a wide variety of applications. For example, the fiber optic assembly 100 as disclosed herein may be utilized in a head mounted display (HMD). In such examples, HMD's including one or more near-eye displays may often be used to present visual content to a user for use in artificial reality applications. One type of near-eye display may include an enclosure that houses components of the display or is configured to rest on the face of a user, such as for example a frame. The near-eye display may include a waveguide that directs light from a fiber optic to a location in front of the user's eyes. Because of human visual sensitivity, slight deviations in optical quality may be apparent to the user of a near-eye display. Proper alignment and propagation of light via interactions between a fiber optic and waveguide into the photonic integrated circuit (PIC) within HMD may allow for improved optical quality or image quality within the HMD system. In such systems, the fiber optic may be the medium through which the signal travels over a long distance and waveguide may be the conduit that couples the light from the fiber optic and channels the light into the PIC.

As such, the improved fiber optic assembly 100 as disclosed herein may control the mode field diameter (MFD) associated with an artificial reality system. Examples may include fiber optics that may include a fiber optic core 255 comprised of at least one transparent layer, a copper layer, a conductive electrode layer, or a liquid crystal layer. The fiber optic core 255 may be configured to direct light to a waveguide associated with a HMD. The fiber optic assembly 100 may be configured to control the mode field diameter (MFD) of the light at the termination of the fiber (e.g., end of fiber optic), via liquid crystal layer, to optimize light coupling into the waveguide.

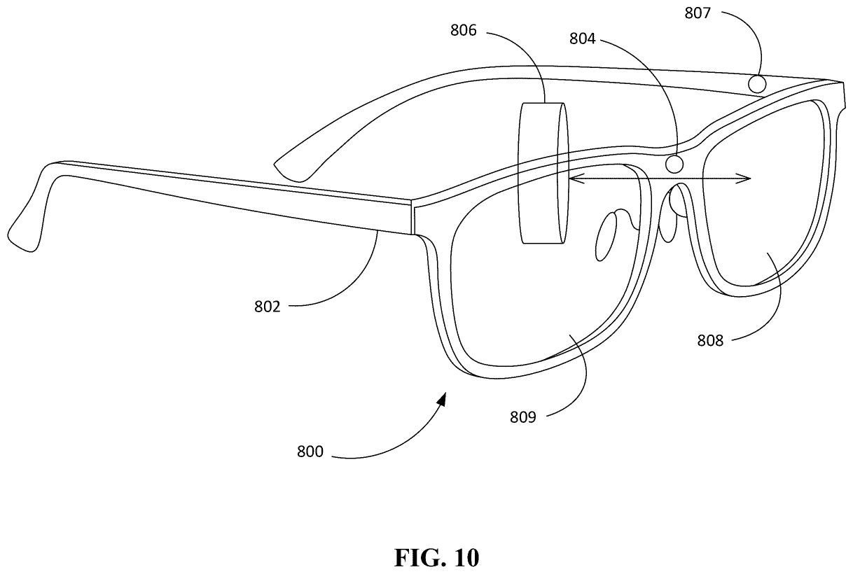

FIG. 10 illustrates an exemplary head-mounted display (HMD) associated with artificial reality content. HMD 800 may include frame 802 (e.g., an eyeglass frame or enclosure), sensor 804, sensor 807, display 808, or display 809. Display 808 or display 809 may include a waveguide and may be configured to direct images to surface 806 (e.g., user's eye or another structure). In some examples, head-mounted display 800 may be implemented in the form of augmented-reality glasses. Accordingly, display 108 may be at least partially transparent to visible light to allow the user to view a real-world environment through display 808.

Tracking of surface 806 may be significant for graphics rendering and user peripheral input. HMD 800 design may include sensor 804 (e.g., a front facing camera away from a user) and sensor 807 (e.g., a rear facing camera towards a user). Sensor 804 or sensor 807 may track movement (e.g., gaze) of eye of user or line of sight associated with user. HMD 800 may include an eye tracking system to track the vergence movement of user. Sensor 804 may capture images or videos of an area, while sensor 807 may capture video or images associated with surface 806 (e.g., eyes of user or other areas of the face). There may be multiple sensors 807 that may be used to detect the reflection off of surface 806 or other movements (e.g., glint or electromyogram (EMG) signals associated with one or more eyes or other parts of the face of user). Sensor 804 or sensor 807 may be located on frame 802 in different positions. Sensor 804 or sensor 807 may have multiple purposes and may encompass the entire width of a section of frame 802, may be just on one side of frame 802 (e.g., nearest to the eyes of user), or may be located on display 808.

Herein, glint may refer to light reflected at an angle from a target surface 806 (e.g., one or more eyes). A glint signal may be any point-like response from the eye from an energy input. Examples of energy inputs may be any form of time, space, frequency, phase, or polarized modulated light or sound. Additionally, glint signals may result from a broad area of illumination where the nature of the field of view from the receiving tracking technology may allow detection of point like response from the surface pixels or the volume voxels of the surface 806 (e.g., combination of the detection system with desired artifacts on the surfaces or layers of the eye or within its volume). This combination of illumination and detection field of views coupled with desired artifacts on the layers or volumes may result in point like responses from surface 806 (e.g., glints).

As disclosed, the methods or systems may use voice, electromyogram (EMG) signals from muscles in the face, body movements (e.g., head bowed or extremity movement), or point-of-gaze coordinates produced by an eye-gaze tracking (EGT) system (e.g., using glint tracking). Voice information, EMG information, extremity movement information, or EGT information may be combined or used separately to create one or more options to control sharing of files (e.g., photos, documents, or other data) using HMD 800.

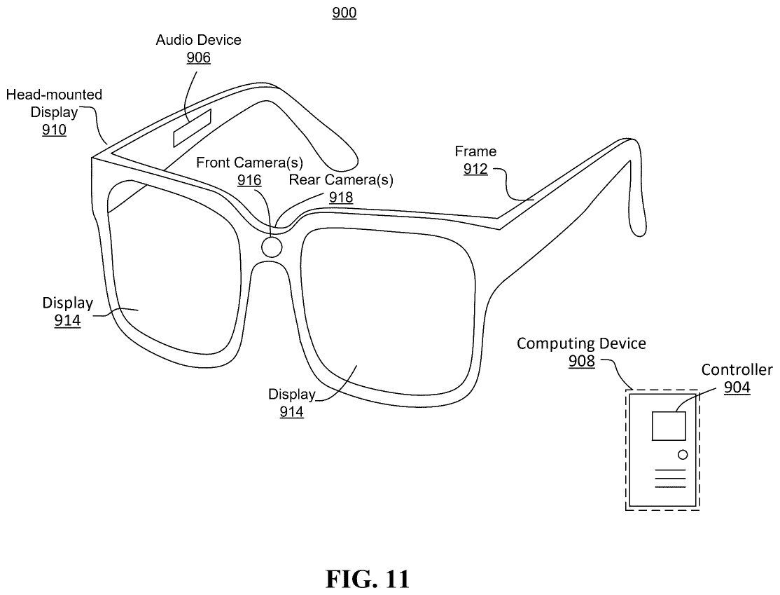

FIG. 11 illustrates an example artificial reality system 900. The artificial reality system 900 may include a head-mounted display (HMD) 910 (e.g., smart glasses) comprising a frame 912, one or more displays 914, and a computing device 908. The displays 914 may be transparent or translucent allowing a user wearing the HMD 910 to look through the displays 914 to see the real world (e.g., real world environment) and displaying visual artificial reality content to the user at the same time. The HMD 910 may include an audio device 906 (e.g., speakers ormicrophones) that may provide audio artificial reality content to users. The HMD 910 may include one or more cameras 916, 918 which may capture images or videos of environments. In one example, the HMD 910 may include a camera(s) 918 which may be a rear-facing camera tracking movement or gaze of a user's eyes.

One of the cameras 916 may be a forward-facing camera capturing images or videos of the environment that a user wearing the HMD 910 may view. The HMD 910 may include an eye tracking system to track the vergence movement of the user wearing the HMD 910. In one example, the camera(s) 918 may be the eye tracking system. In some examples, the camera(s) 918 may be one camera configured to view at least one eye of a user. In some other examples, the camera(s) 918 may include multiple cameras viewing each of the eyes of a user to enhance the capture of an image(s). The HMD 910 may include a microphone of the audio device 906 to capture voice input from the user. The augmented reality system 900 may further include a controller 904 comprising a trackpad and one or more buttons. The controller 904 may receive inputs from users and relay the inputs to the computing device 908. The controller may also provide haptic feedback to one or more users. The computing device 908 may be connected to the HMD 910 and the controller through cables or wireless connections. The computing device 908 may control the HMD 910 and the controller to provide the augmented reality content to and receive inputs from one or more users. In some examples, the controller 904 may be a standalone controller or integrated within the HMD 910. The computing device 908 may be a standalone host computer device, an on-board computer device integrated with the HMD 910, a mobile device, or any other hardware platform capable of providing artificial reality content to and receiving inputs from users. In some examples, HMD 910 may include an artificial reality system or virtual reality system.

FIG. 12 illustrates a block diagram of an example hardware/software architecture of user equipment (UE) 30. As shown in FIG. 12, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

FIG. 13 is a block diagram of an exemplary computing system 1000. In some examples, the network device 720 may be a computing system 1000. The computing system 1000 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 1000 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 1000 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 1000 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 1000. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 1000 may contain communication circuitry, such as for example a network adaptor 97, that may be used to connect computing system 1000 to an external communications network, such as network 12 of FIG. 12, to enable the computing system 1000 to communicate with other nodes (e.g., UE 30) of the network.

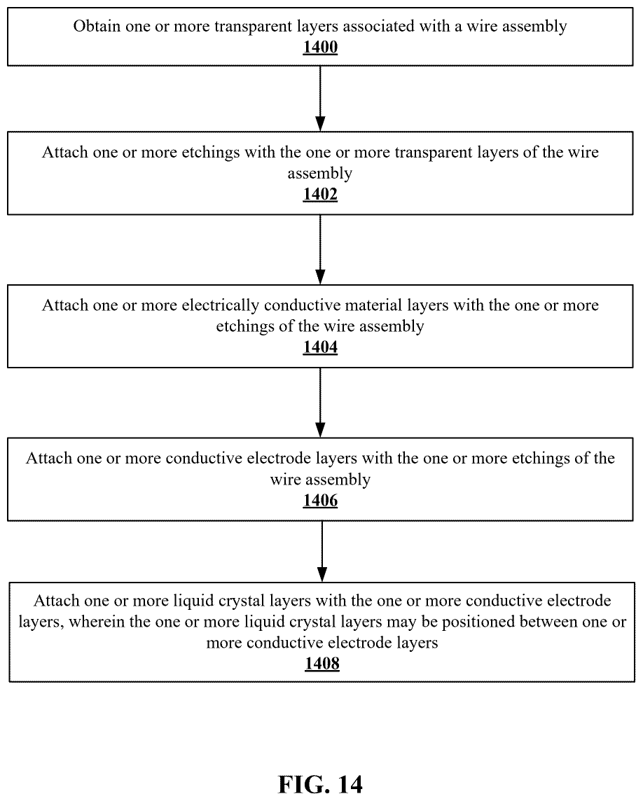

FIG. 14 illustrates an example flowchart illustrating operations associated with a wire assembly according to an example of the present disclosure. In some examples, the wire assembly may be the fiber optic assembly 100. At step 1400, the method may facilitate obtaining one or more transparent layers associated with a wire assembly. At step 1402, the method may facilitate attaching one or more etchings with the one or more transparent layers of the wire assembly. At step 1404, the method may facilitate attaching one or more electrically conductive material layers with the one or more etchings of the wire assembly.

At step 1406, the method may facilitate attaching one or more conductive electrode layers with the one or more etchings of the wire assembly. At step 1408, the method may facilitate attaching one or more liquid crystal layers with the one or more conductive electrode layers. The one or more liquid crystal layers may be positioned between one or more conductive electrode layers.

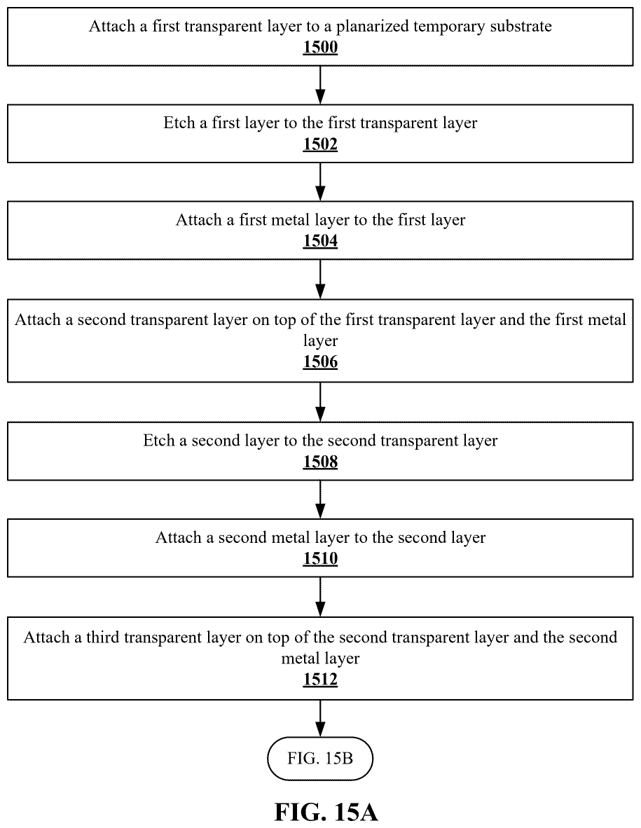

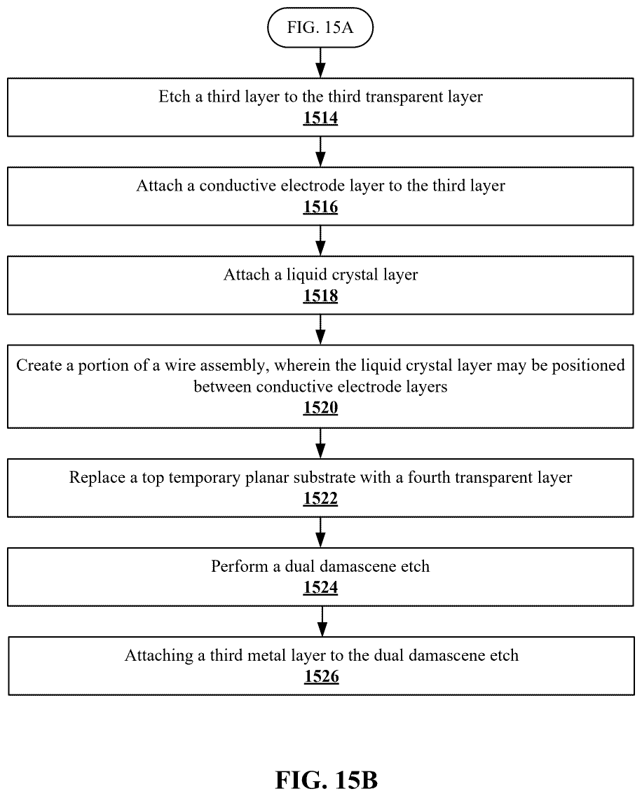

FIG. 15A and FIG. 15B illustrate an example flowchart illustrating operations associated with a wire assembly according to another example of the present disclosure. At step 1500, the method may facilitate attaching a first transparent layer to a planarized temporary substrate. At step 1502, the method may facilitate etching a first layer to the first transparent layer. At step 1504, the method may facilitate attaching a first metal layer to the first layer. At step 1506, the method may facilitate attaching a second transparent layer on top of the first transparent layer and the first metal layer. At step 1508, the method may facilitate etching a second layer to the second transparent layer. At step 1510, the method may facilitate attaching a second metal layer to the second layer. At step 1512, the method may facilitate attaching a third transparent layer on top of the second transparent layer and the second metal layer. At step 1514, the method may facilitate etching a third layer to the third transparent layer. At step 1516, the method may facilitate attaching a conductive electrode layer to the third layer. At step 1518, the method may facilitate attaching a liquid crystal layer. At step 1520, the method may facilitate creating a portion of a wire assembly (e.g., fiber optic assembly 100). The liquid crystal layer may be positioned between one or more conductive electrode layers. At step 1522, the method may facilitate replacing a top temporary planar substrate with a fourth transparent layer. At step 1524, the method may facilitate performing a dual damascene etch. At step 1526, the method may facilitate attaching a third metal layer to the dual damascene etch.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples. It is contemplated that methods may apply to the user or to the group. For example, energizer related alerts may be determined by the groups mood or other wellness information. Energizers may be group related activity rather than an individual related activity.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

The wire assembly may include one or more transparent layers, one or more electrically conductive material layers, and one or more conductive electrode layers deposited on a temporary substrate. The one or more transparent layers may have matching refractive indices. The one or more transparent layers may be etched, where the etched portions of the one or more transparent layers may be filled with electrically conductive material to form electrically conductive material layers. A liquid crystal layer may be sandwiched between two halves of the wire assembly, each half one or more transparent layers, one or more conductive electrode layers, and one or more electrically conductive material layers. The one or more conductive electrode layers are positioned adjacent to the liquid crystal layer. The one or more conductive electrode layers may enable control position or orientation of liquid crystal molecules associated with the one or more liquid crystal layers. The temporary substrate may be removed and replaced with another transparent layer. A dual damascene etch may allow contact between the electrically conductive material layers and a photonic integrated circuit. The wire assembly may be hermetically attached to a fiber optic at one end, with the fiber core aligned to the transparent layers. The other end of the wire assembly may interface with a waveguide associated with a photonic integrated circuit. The electrically conductive material layers making may form an interconnection site with the photonic integrated circuit such that the charge passed between the wire assembly and the photonic integrated circuit may enable adjusting liquid crystal molecules for optimal light transmission to a waveguide.

A system, or apparatus associated with a wire assembly may comprise one or more transparent layers; one or more etchings associated with the one or more transparent layers; one or more electrically conductive material layers associated with the one or more etchings; one or more conductive electrode layers associated with the one or more etchings; and one or more liquid crystal layers associated with the one or more conductive electrode layers, wherein the one or more liquid crystal layers is positioned between one or more conductive electrode layers. The one or more electrically conductive material layers may extend through a diameter of a fiber optic, connecting a photonic integrated circuit to the wire assembly. The wire assembly may be positioned on a terminal end of a fiber optic and placed within a groove of a photonic integrated circuit. The wire assembly may be configured to communicate with the photonic integrated circuit via one or more interconnection sites. The fiber optic may align with a photonic integrated circuit. The fiber optic may comprise a fiber optic core, where the fiber optic core may be aligned to the waveguide based on the alignment of the wire assembly and the photonic integrated circuit. The wire assembly may span a mode field diameter associated with a fiber optic core. The one or more liquid crystal layers may comprise one or more liquid crystal molecules, wherein the one or more liquid crystal molecules may be adjusted based on a potential difference across the one or more liquid crystal layers. This potential difference may be determined based on an association between the one or more electrically conductive layers and the one or more conductive electrode layers. The potential difference determined may adjust the position, orientation, or the like of the liquid crystal molecules to direct light to a waveguide associated with a photonic integrated circuit.

A method, system, or apparatus may comprise obtaining one or more transparent layers associated with a fiber optic assembly; attaching one or more etchings with the one or more transparent layers of the fiber optic assembly; attaching one or more electrically conductive material layers with the one or more etchings of the fiber optic assembly; attaching one or more conductive electrode layers with the one or more etchings of the fiber optic assembly; and attaching one or more liquid crystal layers with the one or more conductive electrode layers, wherein the one or more liquid crystal layers is positioned between one or more conductive electrode layers. The one or more electrically conductive material layers may create a connection between one or more other electrically conductive material layers. The one or more electrically conductive material layers may extend through a diameter of a fiber optic, creating a connection between a fiber optic, the fiber optic assembly, and a photonic integrated circuit. One electrically conductive material layer of the one or more electrically conductive material layers may be configured to span a length of the fiber optic assembly. The one or more electrically conductive material layers may create a connection to a photonic integrated circuit via one or more interconnection sites. The fiber optic assembly may be configured to communicate with a photonic integrated circuit via one or more interconnection sites. The fiber optic assembly may be attached to a terminal end of a fiber optic. The fiber optic assembly may be configured to align with a fiber optic core associated with a fiber optic. The connection between the fiber optic, fiber optic assembly, and the photonic integrated circuit may create an alignment of a fiber optic core associated with the fiber optic and a waveguide associated with the photonic integrated circuit.

A method may comprise attaching a first transparent layer to a top side of a planarized temporary substrate, etching a first layer to the first transparent layer, attaching a first metal layer to the first layer, attaching a second transparent layer on top of the first transparent layer and the first metal layer, etching a second layer to the second transparent layer, attaching a second metal layer to the second layer, attaching a third transparent layer on top of the second transparent layer and the second metal layer, performing a third layer etch on the third transparent layer, attaching a conductive electrode layer on the third transparent layer, attaching a liquid crystal layer, creating a portion of a fiber optic assembly, replacing a top temporary planar substrate with a fourth transparent layer, performing a dual damascene etch, and adding a third metal layer. The third metal layer may create a connection between the first metal layer and the second metal layer. The third metal layer may be configured to span the length of the optical assembly. The first metal layer, the second metal layer, and the third metal layer may be comprised of an electrically conductive material. The liquid crystal layer may be positioned between one or more conductive electrode layers. The planarized temporary substrate may be comprised of silicon, quartz, or any other suitable material with a low coefficient of thermal expansion to prevent bowing or flexing. The first transparent layer, the second transparent layer, the third transparent layer, and the fourth transparent layer may have the same refractive index and may be chemically and mechanically polished to achieve surface uniformity and reduce roughness across the surface of the layer. The electrically conductive material may be copper.

A method may comprise directing a signal to a waveguide associated with a photonic integrated circuit, receiving via a photonic integrated circuit a leakage associated with the signal, determining a potential difference between the photonic integrated circuit and a fiber optic assembly, and adjusting, based on the potential difference, the orientation of a molecule of a liquid crystal layer associated with a fiber optic assembly. The method may further comprise transmitting a message comprising the determined potential difference.

What is claimed:

1. An apparatus comprising:
one or more transparent layers;
one or more etchings associated with the one or more transparent layers;
one or more electrically conductive material layers associated with the one or more etchings;
one or more conductive electrode layers associated with the one or more etchings; and
one or more liquid crystal layers associated with the one or more conductive electrode layers, wherein the one or more liquid crystal layers are positioned between the one or more conductive electrode layers.

2. The apparatus of claim 1, wherein the one or more electrically conductive material layers may extend through a diameter of a fiber optic, connecting a photonic integrated circuit to the apparatus.

3. The apparatus of claim 1, wherein the apparatus is positioned on a terminal end of a fiber optic and placed within a groove of a photonic integrated circuit.

4. The apparatus of claim 3, wherein the apparatus is configured to communicate with the photonic integrated circuit, via one or more interconnection sites.

5. The apparatus of claim 1, wherein a fiber optic is aligned with a photonic integrated circuit.

6. The apparatus of claim 5, further comprising a fiber optic core aligned with a waveguide, wherein the fiber optic core is aligned with the waveguide based on the alignment of the apparatus and the photonic integrated circuit.

7. The apparatus of claim 1, wherein the apparatus spans a mode field diameter associated with a fiber optic core.

8. The apparatus of claim 1, wherein the one or more liquid crystal layers comprises one or more liquid crystal molecules.

9. The apparatus of claim 8, wherein the one or more liquid crystal molecules are adjusted based on a potential difference across the one or more liquid crystal layers, wherein the potential difference is determined based on an association between the one or more electrically conductive layers and the one or more conductive electrode layers.

10. The apparatus of claim 9, wherein the potential difference across the one or more liquid crystal layers adjusts the liquid crystal molecules to direct light to a waveguide associated with a photonic integrated circuit.

11. A method comprising:
obtaining one or more transparent layers associated with a wire assembly;
attaching one or more etchings with the one or more transparent layers of the wire assembly;
attaching one or more electrically conductive material layers with the one or more etchings of the wire assembly;
attaching one or more conductive electrode layers with the one or more etchings of the wire assembly; and
attaching one or more liquid crystal layers with the one or more conductive electrode layers, wherein the one or more liquid crystal layers are positioned between the one or more conductive electrode layers.

12. The method of claim 11, wherein the one or more electrically conductive material layers comprises one electrically conductive material layer that creates a connection between one or more other electrically conductive material layers.

13. The method of claim 11, wherein the one or more electrically conductive material layers may extend through a diameter of a fiber optic creating a connection between the fiber optic, the wire assembly, and a photonic integrated circuit.

14. The method of claim 12, wherein the one of the one or more electrically conductive material layers is configured to span a length of the wire assembly.

15. The method of claim 11, wherein the one or more electrically conductive material layers may create an connection to a photonic integrated circuit via one or more interconnection sites.

16. The method of claim 11, wherein the wire assembly is configured to communicate with a photonic integrated circuit, via one or more interconnection sites.

17. The method of claim 11, wherein the wire assembly is attached to a terminal end of a fiber optic.

18. The method of claim 11, wherein the wire assembly is configured to align with a fiber optic core associated a fiber optic.

19. The method of claim 13, wherein the connection between the fiber optic, the wire assembly, and the photonic integrated circuit creates an alignment of a fiber optic core associated with the fiber optic and a waveguide associated with the photonic integrated circuit.

20. A method comprising:
attaching a first transparent layer to a planarized temporary substrate;
etching a first layer to the first transparent layer;
attaching a first metal layer to the first layer;
attaching a second transparent layer on top of the first transparent layer and the first metal layer;
etching a second layer to the second transparent layer;
attaching a second metal layer to the second layer;
attaching a third transparent layer on top of the second transparent layer and the second metal layer;
etching a third layer to the third transparent layer;
attaching a conductive electrode layer to the third layer;
attaching a liquid crystal layer;
creating a portion of a wire assembly, wherein the liquid crystal layer is positioned between one or more conductive electrode layers;
replacing a top temporary planar substrate with a fourth transparent layer;
performing a dual damascene etch; and
attaching a third metal layer to the dual damascene etch.
